(19) United States
(12) Patent Application Publication
(10) Pub. No.: US 2026/0244565 A1
(43) Pub. Date: Aug. 20, 2026

(54) ERROR HANDLING FOR REPLAY PROTECTED MEMORY BLOCK ACCESS COMMANDS IN A MEMORY SYSTEM

(71) Applicant: Micron Technology, Inc., Boise, ID (US)

(72) Inventors: Pei Pei Jiang, Shanghai (CN); Sibin Wang, Shanghai (CN)

(21) Appl. No.: 19/540,124

(22) Filed: Feb. 13, 2026

Related U.S. Application Data
(60) Provisional application No. 63/761,022, filed on Feb. 20, 2025.

(51) Int. Cl. G06F 12/02; G06F 3/06; G06F 11/07

(52) U.S. Cl. CPC G06F 12/0246; G06F 3/0604; G06F 3/0659; G06F 11/076

(57) ABSTRACT

Methods, systems, and devices for error handling for RPMB access commands in a memory system are described. A memory system may follow one or more rules for determining and handling transfer length errors. In a first rule, the memory system may transmit a response universal flash system (UFS) protocol information unit (UPIU) indicating a check condition status if an expected data transfer length (EDTL) is not equal to a transfer length or an allocation length. The memory system may also skip communicating one or more other UPIUs. In a second rule, the memory system may transmit a UPIU with a general failure result if a block count multiplied by a quantity of bytes is not equal to the EDTL. A command UPIU or a data out UPIU may indicate the block count, and the UPIU with the general failure result may be a data in UPIU or a response UPIU.

### CROSS REFERENCE

The present Application for Patent claims priority to U.S. Patent Application No. 63/761,022 by Jiang et al., entitled “ERROR HANDLING FOR REPLAY PROTECTED MEMORY BLOCK ACCESS COMMANDS IN A MEMORY SYSTEM,” filed Feb. 20, 2025, which is assigned to the assignee hereof, and which is expressly incorporated by reference in its entirety herein.

### TECHNICAL FIELD

The following relates to one or more systems for memory, including error handling for replay protected memory block (RPMB) access commands in a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not- or (NOR) and not- and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports error handling for replay protected memory block (RPMB) access commands in a memory system in accordance with examples as disclosed herein.

FIG. 2 shows a flowchart illustrating a method that supports error handling for RPMB access commands in a memory system in accordance with examples as disclosed herein.

FIGS. 3A and 3B show flowcharts illustrating methods that support error handling for RPMB access commands in a memory system in accordance with examples as disclosed herein.

FIG. 4 shows a block diagram of a memory system that supports error handling for RPMB access commands in accordance with examples as disclosed herein.

FIGS. 5 and 6 show flowcharts illustrating a method or methods that support error handling for RPMB access commands in a memory system in accordance with examples as disclosed herein.

### DETAILED DESCRIPTION

A memory system (e.g., a universal flash storage (UFS) memory system, a UFS memory controller) may include one or more instances of a replay protected memory block (RPMB), which may refer to a portion of memory that is replay protected, such as being accessible only by authenticated access commands. In accordance with some standards (e.g., UFS standards) for accessing an RPMB, a memory system may communicate with a host system using one or more UFS protocol information units (UPIUs) that are associated with (e.g., include) one or more RPMB messages. In some cases of communications with such UPIUs, a memory system may experience a transfer length error in response to an error at the host system or an error of a communication channel (e.g., a UFS channel) between a host system and the memory system. For example, a transfer length error may occur if an expected size of a data transfer or access operation is not equal to an actual size of data to be transferred or accessed. Transfer length errors may occur in various circumstances, such as during various types of data access operations and in different RPMB modes (e.g., a normal RPMB mode, an advanced RPMB mode), and some memory systems may not handle transfer length errors with predictable or desirable responses. For example, in response to determining that a transfer length error has occurred, some memory systems may output an overall command status (OCS) error, a command timeout error, or both, depending on the circumstances. In some cases, an OCS error or a command timeout error may cause latency at such memory systems and reduce performance.

In accordance with techniques described herein, a memory system may follow one or more rules (e.g., processes, techniques, sequences) for determining and handling transfer length errors in an efficient manner. In accordance with a first rule, a memory system may transmit a response UPIU indicating a check condition (e.g., “CHECK CONDITION”) status if a corresponding command UPIU indicates an expected data transfer length (EDTL) that is not equal to a transfer length or an allocation length that is also indicated by the command UPIU (e.g., an example of a transfer length error). In some cases, a memory system may also skip (e.g., refrain from communicating) one or more other UPIUs associated with the command UPIU in response to detecting the transfer length error. In accordance with a second rule, a memory system may transmit a UPIU with a result set to a general failure (e.g., “General Failure”) if a block count multiplied by a threshold quantity of bytes is not equal to an EDTL indicated by a command UPIU. For example, a block count may be indicated to a memory system via a command UPIU, a data out UPIU, or one or more other UPIUs. A UPIU with a result set to a general failure may be a data out UPIU, a data in UPIU, a response UPIU, or one or more other UPIUs. A memory system may apply the first rule, the second rule, or both to a data access sequence (e.g., a data write sequence, a data read sequence, an authenticated data access sequence), which may be implemented in accordance with various RPMB modes (e.g., a normal RPMB mode, an advanced RPMB). Such techniques for handling transfer length errors in a uniform manner may reduce latency and improve performance of a system that includes such a memory system.

In addition to applicability in memory systems as described herein, techniques for error handling for RPMB access commands may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by providing improved error handling techniques for a memory system in the event that fields (e.g., EDTL, block count, transfer length, allocation length) in one or more UPIUs are not in agreement, which may decrease processing or latency times and decrease error propagation in a memory system, among other benefits.

Features of the disclosure are illustrated and described in the context of systems, devices, and circuits. Features of the disclosure are further illustrated and described in the context of flowcharts and block diagrams.

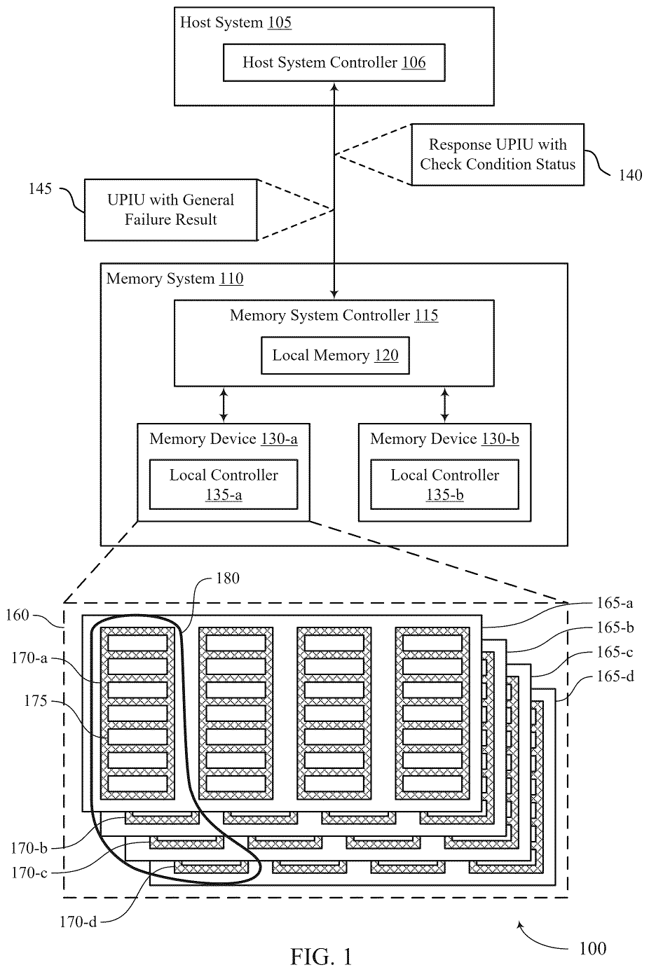

FIG. 1 shows an example of a system 100 that supports error handling for RPMB access commands in a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IOT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130-among other such operations-which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165). In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

A memory system 110 may include an RPMB, such as in one or more of the memory devices 130, in local memory 120, or both. In accordance with some standards (e.g., a UFS standards) for accessing the RPMB, a memory system 110 (e.g., a memory system controller 115) may communicate with a host system 105 (e.g., a host system controller 106) using one or more UPIUs that may include one or more RPMB messages. In some cases of communications with such UPIUs, a memory system 110 may experience a transfer length error in response to an error at a host system 105 or an error of a communication channel (e.g., a UFS channel) between a host system 105 and the memory system 110. For example, a transfer length error may occur if an expected size of a data transfer or access operation is not equal to an actual size of data to be transferred or accessed. Transfer length errors may occur in various circumstances, such as during various types of data access operations and in different RPMB modes (e.g., a normal RPMB mode, an advanced RPMB mode), and some memory systems may not handle transfer length errors with predictable or desirable responses techniques. For example, in response to determining that a transfer length error has occurred, some memory systems may output an OCS error, a command timeout error, or both, depending on the circumstances. In some cases, an OCS error or a command timeout error may cause latency at such memory systems and reduce performance.

In accordance with techniques described herein, a memory system 110 (e.g., a memory system controller 115) may follow one or more rules (e.g., processes, techniques, sequences) for determining and handling transfer length errors in an efficient manner. In accordance with a first rule, a memory system 110 may be configured to transmit a response UPIU 140 (e.g., to a host system 105) indicating a check condition (e.g., “CHECK CONDITION”) status if a corresponding command UPIU indicates an EDTL that is not equal to a transfer length or an allocation length that is also indicated by the command UPIU (e.g., an example of a transfer length error). In some cases, a memory system 110 may also skip (e.g., refrain from communicating) one or more other UPIUs associated with the command UPIU in response to detecting the transfer length error. In accordance with a second rule, a memory system 110 may be configured to transmit a UPIU 145 with a result set to a general failure (e.g., “General Failure”) if a block count multiplied by a threshold quantity of bytes is not equal to an EDTL indicated by a command UPIU. For example, a host system 105 may indicate a block count to a memory system 110 via a command UPIU, a data out UPIU, or one or more other UPIUs. A UPIU with a result set to a general failure may be a data out UPIU, a data in UPIU, a response UPIU, or one or more other UPIUs. A memory system 110 may apply the first rule, the second rule, or both to a data access sequence (e.g., a data write sequence, a data read sequence, an authenticated data access sequence), which may be implemented in accordance with various RPMB modes (e.g., a normal RPMB mode, an advanced RPMB). Such techniques for handling transfer length errors in a uniform manner may reduce latency and improve performance of a system 100.

A system 100 may include any quantity of non-transitory computer readable media that support error handling for RPMB access commands in a memory system. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some memory standards (e.g., a UFS standard), techniques for handling transfer length errors in a memory system may not be defined for certain operations (e.g., RPMB operations, such as normal RPMB operations and advanced RPMB operations). Thus, different memory systems may implement different behaviors for handling transfer length errors in different scenarios or different RPMB operations. Additionally, techniques for handling transfer length errors in some memory systems may not be applicable to all error cases, which may leave a memory system susceptible to increased error propagation or corruption. In some cases, a memory system may indicate an OCS inventory error to a host system in response to detecting a data transfer length error associated with a command, and the host system may abort the command in response to determining a data buffer size mismatch. Additionally, or alternatively, a memory system may freeze (e.g., a firmware may get stuck) in response to determining a transfer length error, which may cause the memory system to indicate a command timeout. Such techniques may cause delays or errors at the memory system, which may decrease performance and user experience.

The techniques described herein introduce one or more rules (e.g., comprehensive rules) with which a memory system 110 (e.g., a memory system controller 115, a memory device 130) may detect transfer length errors and report the transfer length error to a host system 105, which may reduce latency and error propagation due to the transfer length errors (e.g., such as the latency due to OCS inventory errors and command timeout). For example, such rules may provide specific behavior for how a memory system 110 may handle commands (e.g., UPIUs) for RPMB access that are associated with a transfer length error. Accordingly, the rules described herein may enhance error handling capabilities of a memory system 110 while being compatible with one or more memory standards (e.g., UFS standards).

A data access sequence for RPMB may include one or more data access operations, for which each data access operation (e.g., and thus the data access sequence) may include communication of one or more UPIUs that each may include one or more RPMB messages. For example, a data access sequence may be a data read sequence or a data write sequence (e.g., an authorized data read sequence, an authorized data write sequence, among other data access sequences) for normal RPMB access or advanced RPMB access. Data access operations within a data access sequence may include authenticated data write requests, authenticated data read requests, result read requests, result read responses, authenticated data read responses, among other data access operations.

Different types of UPIUs may indicate various information. For example, the types of UPIUs may include command UPIUs, data in UPIUs, data out UPIUs, ready to transfer (RTT) UPIUs, and response UPIUs, among others. In some cases, each data access sequence, as well as each data access operation therein, may be initiated by a command UPIU, and each data access operation may be terminated by a response UPIU. For example, if a host system 105 initiates a data write operation with a command UPIU, a memory system 110 may indicate to the host system 105 that it is ready to receive information by sending the RTT UPIU. In some cases, a single RTT UPIU may request the transfer of one or more RPMB Messages. In response to each RTT UPIU, the host system 105 may deliver the requested portion of the message by sending one or more data out UPIUs, and each data out UPIU may include one or more RPMB messages including the data. In some cases, the memory system 110 may return results or requested data in RPMB message(s) to the host system 105, and the RPMB the message(s) may be delivered by sending one or more data in UPIUs. In some cases, a single data in UPIU may deliver one or more RPMB messages. The memory system 110 may transmit a response UPIU to terminate each data access operation initiated by a corresponding command UPIU. For example, a response UPIU may contain a basic UPIU header plus additional information indicating a corresponding command (e.g., indicated by the corresponding command UPIU), as well as a device level status resulting from successful or failed execution of the command. The memory system 110 may generate the response UPIU and send it to the host system 105 after it has completed the task or data access operation requested by the corresponding command UPIU. Before sending the response UPIU, the memory system 110 may wait until it receives all data out UPIUs (e.g., from the host system) which relate to any outstanding RTT UPIUs.

Command UPIUs may be security protocol out (SPO) command UPIUs or security protocol in (SPI) command UPIUs, according to the data access operation being initiated. For example, SPI command UPIUs may send request messages to a memory system 110, and SPO command UPIUs may request response messages from a memory system 110. A command UPIU may include a basic UPIU header and additional information to specify a command. For example, a host system 105 (e.g., or device, an initiator device) may generate a command UPIU and send it to the memory system 110 (e.g., a memory device 130, a target device) to request a service be performed by the memory system 110. Tables 1, 2, and 3 may illustrate examples of command descriptor blocks (CDBs) that define information included in at least a portion of a command UPIU, an SPO command UPIU, and an SPI command UPIU, respectively.

TABLE 1
Example Command UPIU Definition
Command UPIU

| 0 | 1 | 2 | 3 |
|---|---|---|---|
| xx00 0001b | Flags | Logical Unit | Task Tag |
| | | Number (LUN) | |
| 4 | 5 | 6 | 7 |
| IID/Command Set | Reserved | Reserved | EXT_IID/Reserved |
| Type | | | |
| 8 | 9 | 10 | 11 |
| Total Extra Header | Reserved | Data Segment Length (0000h) | |
| Segment (EHS) | | | |
| Length | | | |
| 12 | 13 | 14 | 15 |

Expected Data Transfer Length (EDTL)

TABLE 2
Example SPO Command UPIU Definition
SPO Command UPIU

| | Bit | | | | | | | |
|---|---|---|---|---|---|---|---|---|
| Byte | 7 | 6 | 5 | 4 | 3 | 2 | 1 | 0 |
| 0 | Operation Code (B5h) | | | | | | | |
| 1 | Security Protocol | | | | | | | |
| 2 | | Security Protocol Specific | | | | | | |
| 3 | | | | | | | | |
| 4 | INC_512 | Reserved | | | | | | |
| 5 | Reserved | | | | | | | |
| 6 | (MSB) | Transfer Length | | | | | | |
| 9 | | | | | | | | (LSB) |

TABLE 3
Example SPI Command UPIU Definition
SPI Command UPIU

| | Bit | | | | | | | |
|---|---|---|---|---|---|---|---|---|
| Byte | 7 | 6 | 5 | 4 | 3 | 2 | 1 | 0 |
| 0 | Operation Code (A2h) | | | | | | | |
| 1 | Security Protocol | | | | | | | |
| 2 | | Security Protocol Specific | | | | | | |
| 3 | | | | | | | | |
| 4 | INC_512 | Reserved | | | | | | |
| 5 | Reserved | | | | | | | |
| 6 | (MSB) | Allocation Length | | | | | | |
| 9 | | | | | | | | (LSB) |

In the EDTL field of a command UPIU (e.g., SPO or SPI command UPIU, as shown in Table 1), an EDTL value for the command UPIU may be indicated. The EDTL value in the EDTL field may represent a threshold number (e.g., quantity) of bytes to be transferred (e.g., which may be required) to complete a command requested by the command UPIU. Additionally, a transfer length field in an SPO command UPIU (e.g., SPO CDB [6-9], as shown in Table 2) may indicate a transfer length value, and an allocation length field in the SPI command UPIU (e.g., SPI CDB [6-9], as show in Table 3) may indicate an allocation length value. For example, the value of the allocation length indicated in the allocation length field may specify a threshold (e.g., maximum) number (e.g., quantity) of bytes of buffer space that a memory system 110 or host system 105 may allocate for data reception associated with the SPO command UPIU, and the value of the transfer length in the transfer length field may indicate a number (e.g., quantity) of contiguous logical blocks of data that the memory system 110 may read and transfer in association with the command UPIU.

In some examples, one or more RPMB messages may indicate a block count in accordance with a mode of the RPMB. For example, there may be multiple RPMB modes, including normal RPMB mode and advanced RPMB mode. In some examples, RPMB messages for normal RPMB may be composed of one or more RPMB Message Data Frames, and each RPMB Message Data Frame size may be 512 byte block. In some other examples, an RPMB message for advanced RPMB may be composed of an advanced RPMB meta information and a message authentication code (MAC) or key in an extra header segment (EHS) field in a command UPIU and or response UPIU. Advanced RPMB data may be delivered through a data segment in data in UPIUs and data out UPIUs, and advanced RPMB data may be transmitted in blocks of 4096 bytes (e.g., in multiples of 4 kilobytes (Kbytes)). Additionally, an advanced RPMB message may be organized in the EHS field, such that the advanced RPMB meta information may be included in the EHS field. Additionally, in some cases, advanced RPMB data access sequences may include fewer data access operations than normal RPMB data access sequences (e.g., such as only one advanced RPMB data access operation) to complete similar tasks. For example, the advanced RPMB messages may include more information than the normal RPMB messages.

For normal RPMB, a block count may be indicated in a block count field in each RPMB message data frame, as indicated in Table 4. For example, the block count for normal RPMB may indicate a quantity of logical block (e.g., 256-byte logical blocks) requested to be read or programmed in a data access operation at the memory system. For Advanced RPMB, the block count may be indicated in a block count field in the advanced RPMB meta information in the EHS, as indicated in Table 5. For example, a block count for advanced RPMB may indicate a quantity of logical blocks (e.g., 4 Kbyte advanced RPMB data, 4096 byte RPMB data) requested to be read or programmed in a data access operation at a memory system 110.

TABLE 4
Example RPMB Message Data Frame Definition
RPMB Message Data Frame

| | Bit | | | | | | | |
|---|---|---|---|---|---|---|---|---|
| Byte | 7 | 6 | 5 | 4 | 3 | 2 | 1 | 0 |
| 0 | (MSB) | Stuff Bytes | | | | | | |
| 195 | | | | | | | | (LSB) |
| 196 | (MSB) | Key/MAC | | | | | | |
| 227 | | | | | | | | (LSB) |
| 228 | Data [255] | | | | | | | |
| 483 | Data [0] | | | | | | | |
| 484 | (MSB) | Nonce | | | | | | |
| 499 | | | | | | | | (LSB) |
| 500 | (MSB) | Write Counter | | | | | | |
| 503 | | | | | | | | (LSB) |
| 504 | (MSB) | Address | | | | | | |
| 505 | | | | | | | | (LSB) |
| 506 | (MSB) | Block Count | | | | | | |
| 507 | | | | | | | | (LSB) |

TABLE 5
Example Advanced RPMB Meta Information Definition
Advanced RPMB Meta Information

| | Bit | | | | | | | |
|---|---|---|---|---|---|---|---|---|
| Byte | 7 | 6 | 5 | 4 | 3 | 2 | 1 | 0 |
| 0 | (MSB) | Request Message Type/Response | | | | | | |
| 1 | | Message Type | | | | | | (LSB) |
| 2 | (MSB) | Nonce | | | | | | |
| 17 | | | | | | | | (LSB) |
| 18 | (MSB) | Write Counter | | | | | | |
| 21 | | | | | | | | (LSB) |
| 22 | (MSB) | Address/LUN | | | | | | |
| 23 | | | | | | | | (LSB) |
| 24 | (MSB) | Block Count | | | | | | |
| 25 | | | | | | | | (LSB) |

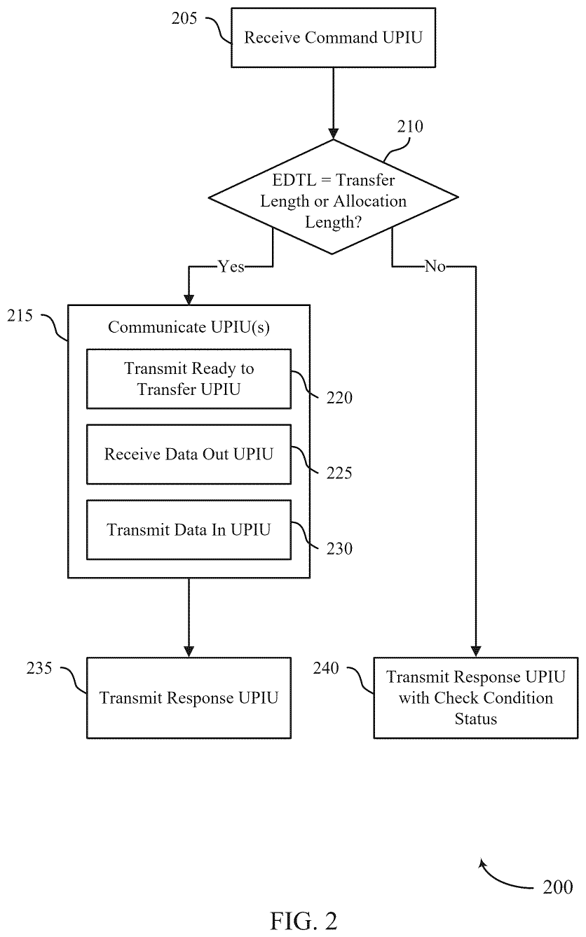

FIG. 2 shows a flowchart illustrating a method 200 that supports error handling for RPMB access commands in a memory system in accordance with examples as disclosed herein. The method 200 may illustrate an example implementation by a memory system 110 (e.g., a memory system controller 115) of a first rule for transfer length error handling for one or more RPMB data access operations, including at least authenticated data write and read sequences for normal and advanced RPMB. For example, in accordance with the method 200, a memory system 110 may determine whether an EDTL is equal to a transfer length or an allocation length (e.g., whichever is indicated by a host system 105 in a command UPIU), and may transmit a response UPIU with a check condition status if the EDTL is not equal to the transfer length or the allocation length.

In the following description of the method 200, operations may be performed in a different order than the order shown, or other operations may be added to or removed. For example, some operations may be omitted from the method 200, may be performed in different orders or at different times, or other operations may be added to the method 200. Operations of the method 200 may be performed by a memory system 110 (e.g., a memory system controller 115, a UFS memory system, a UFS controller), or some aspects of some operations may be performed by one or more other devices or systems, such as a host system 105 (e.g., a host system controller 106). In some cases, operations performed by the memory system 110 may be implemented in instructions or firmware stored on the memory system 110 (e.g., at a memory system controller 115, in local memory 120, in memory devices 130) and executed by the memory system controller 115 (e.g., and/or local controllers 135). For example, the instructions, if executed by a memory system controller 115, may cause the memory system controller 115 to perform the operations of the method 200.

The method 200 may illustrate an implementation of a first rule for transfer length error handling in RPMB access. For example, the first rule may indicate that, if the EDTL value (e.g., as indicated in a command UPIU) is not equal to the transfer length or allocation length (e.g., depending on whether the command UPIU is an SPO or SPI command UPIU), a memory system 110 may be configured to transmit a response UPIU (e.g., terminating the command indicated by the command UPIU) with a check condition status. Additionally, or alternatively, a sense key in the response UPIU may be set to illegal request (“ILLEGAL REQUEST”), an additional sense code in the response UPIU may be set to invalid field in CDB (“INVALID FIELD IN CDB”), or both, in response to the EDTL not being equal to the transfer length or the allocation length. In some implementations, a memory system 110 may, in response to detecting that the EDTL value is not equal to the transfer length or allocation length (e.g., detecting a transfer length error), refrain from communicating one or more other UPIUs prior to transmitting the response UPIU, such as one or more RTT UPIUs, data in UPIUs, or data out UPIUs, which may otherwise be communicated. Although method 200 may illustrate the first rule in some scenarios, the first rule may be applied to any RPMB access scenario, including normal RPMB and advanced RPMB operations or sequences.

At 205, a command UPIU associated with a data access sequence for an RPMB may be received. For example, a memory system 110 (e.g., a memory system controller 115, a UFS controller) may receive a command UPIU (e.g., from a host system 105). In some cases, the command UPIU may include a first indication of an EDTL (e.g., as shown in Table 1) of the command UPIU and a second indication of a second length of the command UPIU. For example, the second length may be a transfer length of the command UPIU or an allocation length of the command UPIU (e.g., such as those described in Tables 2 and 3). In some cases, the data access sequence may be any RPMB operation (e.g., normal or advanced RPMB). For example, the data access sequence may include an authenticated data write sequence or an authenticated data read sequence in accordance with normal RPMB operations or advanced RPMB operations at the memory system 110.

In a case where the data access sequence in an advanced RPMB data access sequence, the command UPIU may include an EHS. Additionally, the command UPIU may initiate the data access sequence, as opposed to being a subsequent command UPIU in the data access sequence. For example, advanced RPMB data access sequences may include one (e.g., only one) command UPIU, which may initiate the data access sequence. In the case where the data access sequence is a normal RPMB data access sequence, the command UPIU may initiate the data access sequence, or may be a subsequent command UPIU in the data access sequence that does not initiate the data access sequence (e.g., only initiates a data access operation of the data access sequence).

At 210, a determination of whether the EDTL indicated in the command UPIU is equal to the second length of the command UPIU (e.g., the transfer length or the allocation length, whichever is also indicated in the command UPIU) may be made. For example, the memory system 110 (e.g., the memory system controller 115) may determine whether the EDTL is equal to the second length. If the EDTL is determined to be equal to the second length, the method 200 may advance to 215. Otherwise, the method 200 may advance to 240.

At 215, if the EDTL is determined to be equal to the second length, one or more UPIUs of the data access sequence may be communicated. For example, the memory system 110 (e.g., the memory system controller 115 or another host interface component of the memory system 110) may communicate the one or more UPIUs with the host system 105 (e.g., the host system associated with the command UPIU), which may involve the memory system 110 transmitting or receiving the one or more UPIUs to or from the host system 105. In some cases, the one or more UPIUs may include one or more of an RTT UPIU, a data out UPIU, and a data in UPIU. For example, at 220, the memory system 110 may transmit an RTT UPIU associated with the command UPIU to indicate a readiness of the memory system 110 to transfer data (e.g., to or from the memory system). Additionally, or alternatively, at 225, the memory system 110 may receive a data out UPIU which may carry one or more RPMB messages indicating data to transfer to or read from the memory system 110. Additionally, or alternatively, at 230, the memory system 110 may transmit a data in UPIU associated with the command UPIU, which may carry one or more RPMB messages indicating data to transfer to the host system 105.

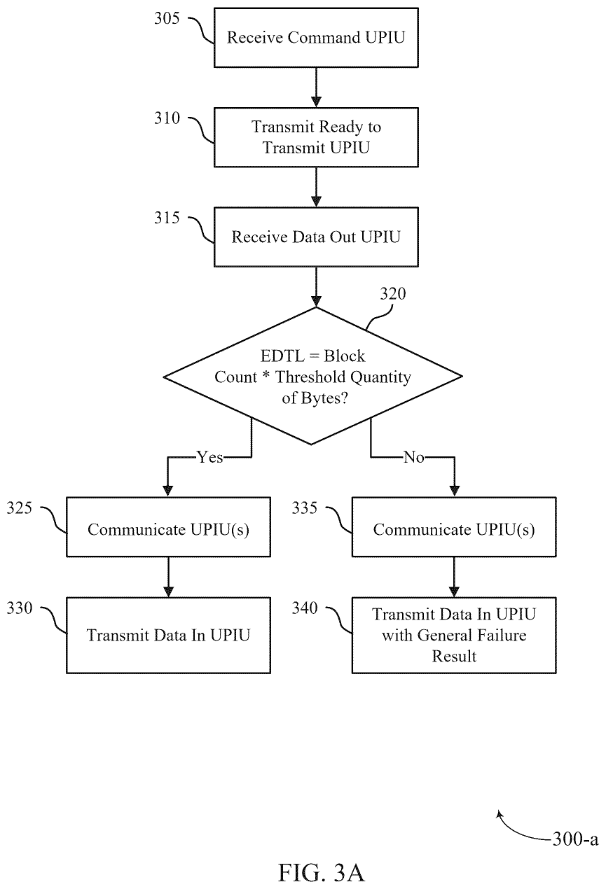

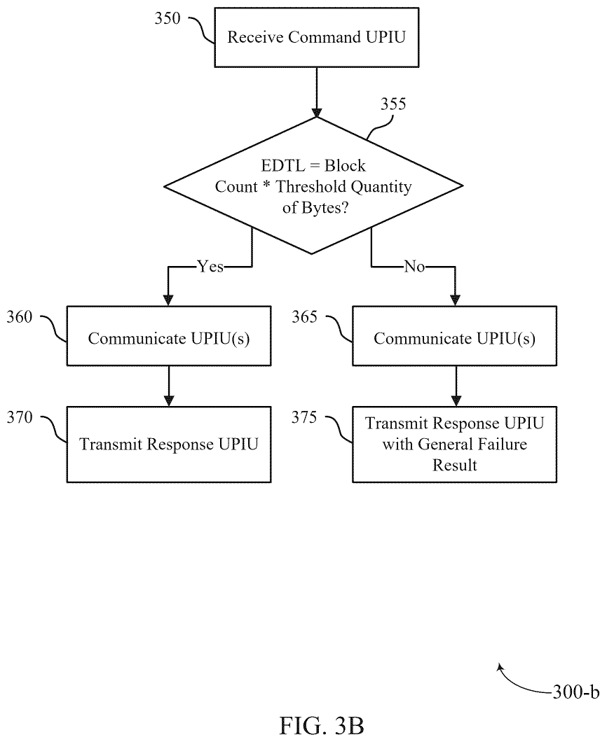

In some cases (e.g., to implement the second rule, as described herein with reference to FIGS. 3A and 3B), a third indication of a block count associated with the data access sequence may be received. For example, the memory system 110 (e.g., the memory system controller 115 or another interface component of the memory system 110) may receive the third indication of the block count (e.g., from the host system 105). In some cases, the block count may be indicated in the command UPIU (e.g., such as in advanced RPMB meta information, as shown in Table 5) or in the data out UPIU (e.g., such as at 225, in an RPMB message data frame as shown in Table 4). In some cases, the memory system 110 may determine whether the block count multiplied by a threshold quantity of bytes (e.g., as described with reference to FIGS. 3A and 3B) is equal to the EDTL, and may transmit a UPIU associated with the data access sequence. For example, if the block count multiplied by the threshold quantity of bytes is not equal to the EDTL, the UPIU may include a result set to general failure. In some cases, the UPIU may be a data in UPIU (e.g., such as at 230, in the case of normal RPMB data access sequences) or a response UPIU (e.g., such as at 235 or 240, in the case of advanced RPMB data access sequences).

At 235, a response UPIU may be transmitted. For example, the memory system 110 (e.g., the memory system controller 115 or another interface component of the memory system 110) may transmit the response UPIU (e.g., to the host system 105). In response to determining that the EDTL is equal to the second length of the command UPIU, the response UPIU may not include a check condition status, a sense key set to illegal request, an additional sense code set to invalid field in CDB, or any combination thereof.

At 240, if it is determined that the EDTL is not equal to the second length of the command UPIU, a response UPIU including a check condition status may be transmitted. For example, the memory system 110 (e.g., the memory system controller 115 or another interface component of the memory system 110) may transmit the UPIU (e.g., to the host system 105). Additionally, or alternatively, the response UPIU at 240 may include a sense key in the response UPIU set to illegal request, an additional sense code in the response UPIU set to invalid field in CDB, or both. In some cases, the response UPIU may correspond to the command UPIU, or may terminate a data access operation initiated by the command UPIU. The response UPIU may be transmitted in response to the command UPIU, as opposed to in response to another command UPIU in the data access sequence.

Additionally, or alternatively, in response to determining that the EDTL does not equal the second length, the memory system 110 may refrain from communicating one or more UPIUs of the data access sequence (e.g., such as the one or more UPIUs described herein at 215). For example, the memory system 110 may allow a duration for communicating the one or more UPIUs to lapse without communicating the one or more UPIUs in response to determining that the EDTL is not equal to the second length.

In accordance with one or more aspects of the method 200, a memory system 110 may determine and handle transfer length errors with decreased latency and error propagation as opposed to other techniques. Additionally, the techniques of the method 200 (e.g., the first rule) may be combined with techniques of the method 300 described with reference to FIGS. 3A and 3B (e.g., the second rule) for transfer length error handling.

FIGS. 3A and 3B show flowcharts illustrating methods 300 (e.g., a method 300-a and a method 300-b) that support error handling for RPMB access commands in a memory system in accordance with examples as disclosed herein. The methods 300 may illustrate example implementations by a memory system 110 (e.g., a memory system controller 115) of a second rule for transfer length error handling for one or more RPMB data access operations. For example, the method 300-a may illustrate the application of the second rule to normal RPMB data access sequences and operations, and the method 300-b may illustrate the application of the second rule to advanced RPMB data access sequences and operations. In accordance with the methods 300, a memory system 110 may determine whether an EDTL is equal to a block count multiplied by a threshold quantity of bytes, and may transmit a UPIU with a result set to general failure if the EDTL is not equal to the block count multiplied by the threshold quantity of bytes.

In the following description of the method 300, operations may be performed in a different order than the order shown, or other operations may be added to or removed. For example, some operations may be omitted from the method 300, may be performed in different orders or at different times, or other operations may be added to the method 300. Operations of the method 300 may be performed by a memory system 110 (e.g., a memory system controller 115, a UFS memory system, a UFS controller), or some aspects of some operations may be performed by one or more other devices or systems, such as a host system 105 (e.g., a host system controller 106). In some cases, operations performed by the memory system 110 may be implemented in instructions or firmware stored on the memory system 110 (e.g., at a memory system controller 115, in local memory 120, in memory devices 130) and executed by the memory system controller 115 (e.g., and/or local controllers 135). For example, the instructions, if executed by a memory system controller 115, may cause the memory system controller 115 to perform the operations of the method 300.

The methods 300 may illustrate application of the second rule for transfer length error handling in RPMB accesses. The second rule may indicate that, if a block count multiplied by a threshold quantity of bytes is not equal to the EDTL indicated in the command UPIU, the memory system 110 may be configured to transmit a UPIU with a result set to General failure (e.g., “0001 h”). Although methods 300 may illustrate the second rule in some scenarios, the second rule may be applied to any RPMB access scenario, including normal RPMB and advanced RPMB operations or sequences. Additionally, the second rule may be applied in conjunction with the first rule to a same data access sequence to determine and handle transfer length errors.

In the method 300-a, at 305, a command UPIU may be received. For example, a memory system 110 (e.g., a memory system controller 115, a UFS interface component, or other interface component) may receive the command UPIU (e.g., from a host system 105). In some cases, the command UPIU may initiate an RPMB data access sequence, and may include a first indication of an EDTL of the command UPIU. In some cases of the method 300-a, the data access sequence may include a data write sequence or data read sequence in accordance with normal RPMB operations at the memory system.

At 310, an RTT UPIU may be transmitted. For example, the memory system 110 (e.g., the memory system controller 115, the UFS interface component, or other interface component) may transmit the RTT UPIU (e.g., to the host system 105).

At 315, a data out UPIU may be received. For example, the memory system 110 (e.g., the memory system controller 115, the UFS interface component, or other interface component) may receive the data out UPIU (e.g., from the host system 105). In some cases, the data out UPIU may include a second indication of a block count associated with the data access sequence or the command UPIU. For example, the data out UPIU may include an RPMB message data frame including a block count field indicating the block count (e.g., as shown in Table 4).

At 320, a determination as to whether the EDTL is equal to the block count multiplied by a threshold quantity of bytes may be made. For example, in response to receiving the second indication of the block count, the memory system 110 (e.g., the memory system controller 115, the UFS interface component, or other logic component) may determine whether the EDTL equals the block count multiplied by the threshold quantity of bytes. In normal RPMB, the threshold quantity of bytes may be 512 bytes, or a standard block size of normal RPMB data. The method 300-a may advance to 325 if the EDTL is equal to the block count multiplied by the threshold quantity of bytes, or may advance to 330 if the EDTL is not equal to the block count multiplied by the threshold quantity of bytes.

At 325 and 335 (e.g., regardless of whether the EDTL is equal to the product of the block count and the threshold quantity of bytes), one or more UPIUs may be communicated. For example, the memory system 110 (e.g., the memory system controller 115, the UFS interface component, or other interface component) may communicate the one or more UPIUs (e.g., with the host system 105), which may involve the memory system 110 transmitting or receiving the UPIUs to or from the host system 105. In some cases, the one or more UPIUs may include RTT UPIUs, data in UPIUs, data out UPIUs, response UPIUs, other command UPIUs, or any combination thereof. For example, the host system 105 may transmit one or more other command UPIUs to initiate one or more other data access operations in the data access sequence, and the one or more other data access operations may include communication of the one or more UPIUs.

At 330, after communicating the UPIUs at 325 and if the EDTL is equal to the product of the block count and threshold quantity of bytes, a data in UPIU may be transmitted. For example, the memory system 110 (e.g., the memory system controller 115, the UFS interface component, or other interface component) may transmit the data in UPIU (e.g., to the host system 105). The memory system 110 may not set a result of the data in UPIU to general failure in response to determining that the EDTL is equal to the block count multiplied by the threshold quantity of bytes.

At 340, after communicating the UPIUs at 335 and if the EDTL is not equal to the product of the block count and the threshold quantity of bytes, a UPIU associated with the data access sequence and including a result set to general failure may be transmitted. That is, the memory system 110 may set a result of the UPIU to general failure in response to determining that the EDTL is not equal to the block count multiplied by the threshold quantity of bytes. In some cases, the UPIU may be a data in UPIU (e.g., in the case of normal RPMB), and the memory system 110 (e.g., the memory system controller 115, the UFS interface component, or other interface component) may transmit the UPIU (e.g., to the host system 105). Additionally, or alternatively, the memory system 110 may transmit the UPIU with the general failure result in response to (e.g., only if) the second indication of the block count indicates that the block count is greater than zero. That is, if the block count is zero, the memory system 110 may perform the actions of 325 and 335, or may perform one or more other actions such as indicating other errors to the host system 105.

In the method 300-b, at 350 (e.g., similar to 305), a command UPIU may be received. For example, a memory system 110 (e.g., a memory system controller 115, a UFS interface component, or other interface component) may receive the command UPIU (e.g., from a host system 105). In some cases, the command UPIU may initiate a data access sequence, and the data access sequence may include a data write sequence or data read sequence in accordance with advanced RPMB operations at the memory system 110. In some cases, the command UPIU may include a first indication of an EDTL of the command UPIU. Additionally (e.g., according to advanced RPMB operations), the command UPIU may include a second indication of a block count associated with the data access sequence. For example, the command UPIU may include an EHS that includes the second indication of the block count (e.g., such as in the advanced RPMB meta information, as shown in Table 5).

At 355, whether the EDTL is equal to the block count multiplied by a threshold quantity of bytes may be determined. For example, in response to receiving the indication of the EDTL and the second indication of the block count, the memory system (e.g., the memory system controller 115, the UFS interface component, or other logic component) may determine whether the EDTL is equal to the product of the block count and the threshold quantity of bytes. In the case of advanced RPMB operations, the threshold quantity of bytes may be 4096 bytes, or a standard block size for advanced RPMB data. The method 300-b may advance to 360 if the EDTL is equal to the product of the block count and the threshold quantity of bytes, or may advance to 365 if the EDTL is not equal to the product of the block count and the threshold quantity of bytes.

At 360 and 365 (e.g., regardless of whether the EDTL is equal to the block count multiplied by the threshold quantity of bytes), one or more UPIUs may be communicated. The operations of 360 and 365 may be similar to the operations of 325 and 330 of the method 300-a.

At 370, a response UPIU may be transmitted. For example, the memory system 110 (e.g., the memory system controller 115 or another interface component of the memory system 110) may transmit the response UPIU (e.g., to the host system 105). In some cases, the memory system 110 may not set a result of the response UPIU to general failure in response to determining that the EDTL is equal to the product of the block count and the threshold quantity of bytes.

At 375, in response to determining that the block count multiplied by a threshold quantity of bytes is not equal to the EDTL, a UPIU associated with the data access sequence and including a result set to general failure may be transmitted. For example, the memory system 110 (e.g., the memory system controller 115 or another interface component of the memory system 110) may transmit the UPIU (e.g., to the host system 105). In some cases, the UPIU may be a response UPIU that is transmitted in response to the command UPIU. For example, the response UPIU may correspond to the command UPIU and may terminate a data access operation or sequence initiated by the command UPIU. In some examples, the memory system 110 may transmit the UPIU to the host system 105 in response to the second indication of the block count indicating that the block count is greater than zero. For example, if the second indication of the block count indicates a block count of zero, the memory system 110 may perform the operations of 360 and 370, or may perform other operations such as transmitting a different error indication to the host system 105.

A memory system 110 that is configured to implement the techniques described herein may experience enhanced error handling capabilities, specifically for transfer length errors. For example, error handling capabilities of the memory system 110 may be more robust (e.g., able to handle transfer length errors in more scenarios) and effective (e.g., reducing latency in handling transfer length errors) compared to memory systems that do not implement the first rule, the second rule, or both. Additionally, such error handling capabilities may not affect other aspects of RPMB performance at the memory system 110, allowing for ease of integration with other techniques.

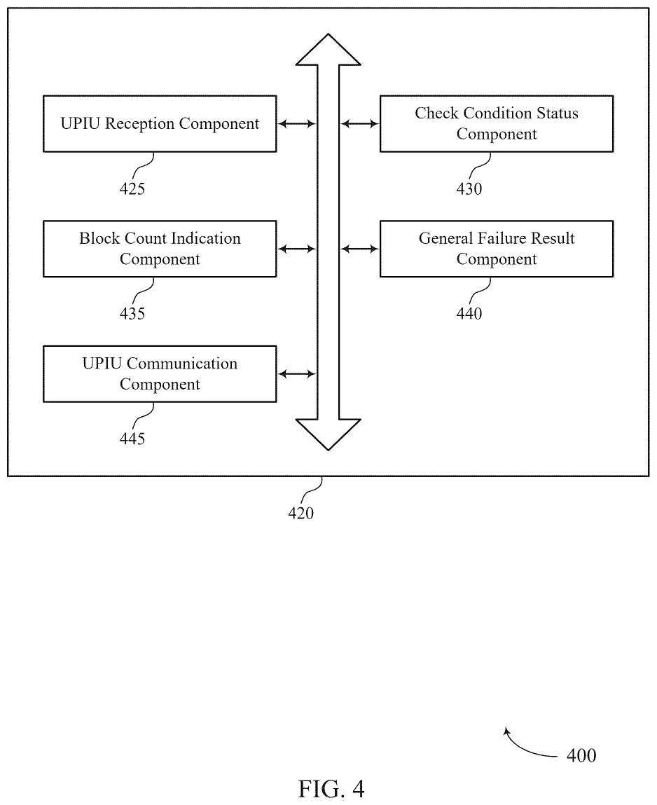

FIG. 4 shows a block diagram 400 of a memory system 420 that supports error handling for RPMB access commands in a memory system in accordance with examples as disclosed herein. The memory system 420 may be an example of aspects of a memory system as described with reference to FIGS. 1 through 3. The memory system 420, or various components thereof, may be an example of means for performing various aspects of error handling for RPMB access commands in a memory system as described herein. For example, the memory system 420 may include a UPIU reception component 425, a check condition status component 430, a block count indication component 435, a general failure result component 440, a UPIU communication component 445, or any combination thereof. Each of these components, or components of subcomponents thereof (e.g., one or more processors, one or more memories), may communicate, directly or indirectly, with one another (e.g., via one or more buses).

The memory system 420 may support memory operations in accordance with examples as disclosed herein. The UPIU reception component 425 may be configured as or otherwise support a means for receiving a command UPIU associated with a data access sequence for an RPMB of the memory system 420, the command UPIU including a first indication of an EDTL of the command UPIU and a second indication of a second length of the command UPIU. The check condition status component 430 may be configured as or otherwise support a means for transmitting a response UPIU including a check condition status in response to determining that the EDTL does not equal the second length.

In some examples, the second length is a transfer length of the command UPIU or an allocation length of the command UPIU.

In some examples, the data access sequence is an authenticated data write sequence in accordance with RPMB operations at the memory system 420.

In some examples, the data access sequence is an authenticated data read sequence in accordance with RPMB operations at the memory system 420.

In some examples, the response UPIU is transmitted in response to the command UPIU.

In some examples, the command UPIU includes an EHS and initiates the data access sequence.

In some examples, the UPIU communication component 445 may be configured as or otherwise support a means for refraining from communicating one or more UPIUs of the data access sequence in response to determining that the EDTL does not equal the second length of the command UPIU, where the one or more UPIUs include one or more of a ready to transfer UPIU associated with the command UPIU, a data out UPIU associated with the command UPIU, and a data in UPIU associated with the command UPIU.

In some examples, the block count indication component 435 may be configured as or otherwise support a means for receiving a third indication of a block count associated with the data access sequence. In some examples, the general failure result component 440 may be configured as or otherwise support a means for transmitting a UPIU associated with the data access sequence, the UPIU including a result set to general failure in response to determining that the block count multiplied by a threshold quantity of bytes is not equal to the EDTL.

Additionally, or alternatively, the memory system 420 may support memory operations in accordance with examples as disclosed herein. In some examples, the UPIU reception component 425 may be configured as or otherwise support a means for receiving a command UPIU that initiates a data access sequence for an RPMB at the memory system 420, the command UPIU including a first indication of an EDTL of the command UPIU. The block count indication component 435 may be configured as or otherwise support a means for receiving a second indication of a block count associated with the data access sequence. The general failure result component 440 may be configured as or otherwise support a means for transmitting a UPIU associated with the data access sequence, the UPIU including a result set to general failure in response to determining that the block count multiplied by a threshold quantity of bytes is not equal to the EDTL.

In some examples, the data access sequence includes a data write sequence in accordance with RPMB operations at the memory system 420.

In some examples, the data access sequence includes a data read sequence in accordance with RPMB operations at the memory system 420.

In some examples, to support receiving the second indication of the block count, the block count indication component 435 may be configured as or otherwise support a means for receiving a data out UPIU associated with the command UPIU, where the data out UPIU includes the second indication of the block count.

In some examples, the threshold quantity of bytes is 512 bytes.

In some examples, the command UPIU includes an EHS that includes the second indication of the block count. In some examples, the UPIU including the result set to general failure includes a response UPIU transmitted in response to the command UPIU.

In some examples, the threshold quantity of bytes is 4096 bytes.

In some examples, the UPIU including the general failure result is transmitted in response to the second indication of the block count indicating that the block count is greater than zero.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

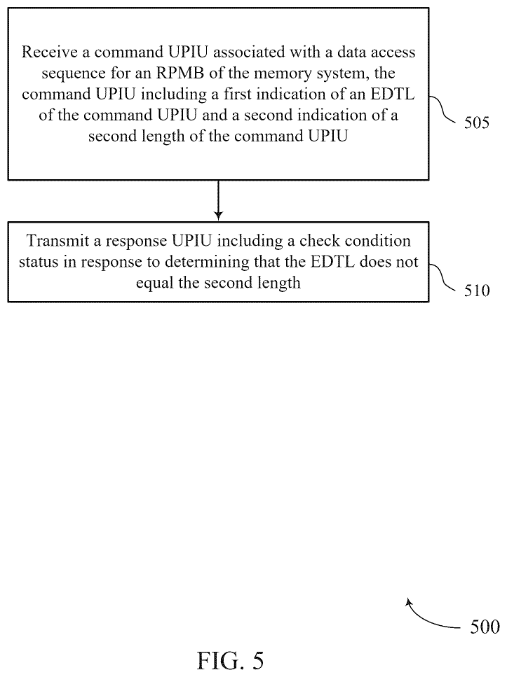

FIG. 5 shows a flowchart illustrating a method 500 that supports error handling for RPMB access commands in a memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving a command UPIU associated with a data access sequence for an RPMB of the memory system, the command UPIU including a first indication of an EDTL of the command UPIU and a second indication of a second length of the command UPIU. In some examples, aspects of the operations of 505 may be performed by a UPIU reception component 425 as described with reference to FIG. 4.

At 510, the method may include transmitting a response UPIU including a check condition status in response to determining that the EDTL does not equal the second length. In some examples, aspects of the operations of 510 may be performed by a check condition status component 430 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for receiving a UPIU associated with a data access sequence for an RPMB of the memory system, the command UPIU including a first indication of an EDTL of the command UPIU and a second indication of a second length of the command UPIU and transmitting a response UPIU including a check condition status in response to determining that the EDTL does not equal the second length.
Aspect 2: The method, apparatus, or non-transitory computer-readable medium of aspect 1, where the second length is a transfer length of the command UPIU or an allocation length of the command UPIU.
Aspect 3: The method, apparatus, or non-transitory computer-readable medium of any of aspects 1 through 2, where the data access sequence is an authenticated data write sequence in accordance with RPMB operations at the memory system.
Aspect 4: The method, apparatus, or non-transitory computer-readable medium of any of aspects 1 and 2, where the data access sequence is an authenticated data read sequence in accordance with RPMB operations at the memory system.
Aspect 5: The method, apparatus, or non-transitory computer-readable medium of any of aspects 1 through 4, where the response UPIU is transmitted in response to the command UPIU.
Aspect 6: The method, apparatus, or non-transitory computer-readable medium of any of aspects 1 through 5, where the command UPIU includes an EHS and initiates the data access sequence.
Aspect 7: The method, apparatus, or non-transitory computer-readable medium of any of aspects 1 through 6, further including operations, features, circuitry, logic, means, or instructions, or any combination thereof for refraining from communicating one or more UPIUs of the data access sequence in response to determining that the EDTL does not equal the second length of the command UPIU, where the one or more UPIUs include one or more of a ready to transfer UPIU associated with the command UPIU, a data out UPIU associated with the command UPIU, and a data in UPIU associated with the command UPIU.
Aspect 8: The method, apparatus, or non-transitory computer-readable medium of any of aspects 1 through 7, further including operations, features, circuitry, logic, means, or instructions, or any combination thereof for receiving a third indication of a block count associated with the data access sequence and transmitting a UPIU associated with the data access sequence, the UPIU including a result set to general failure in response to determining that the block count multiplied by a threshold quantity of bytes is not equal to the EDTL.

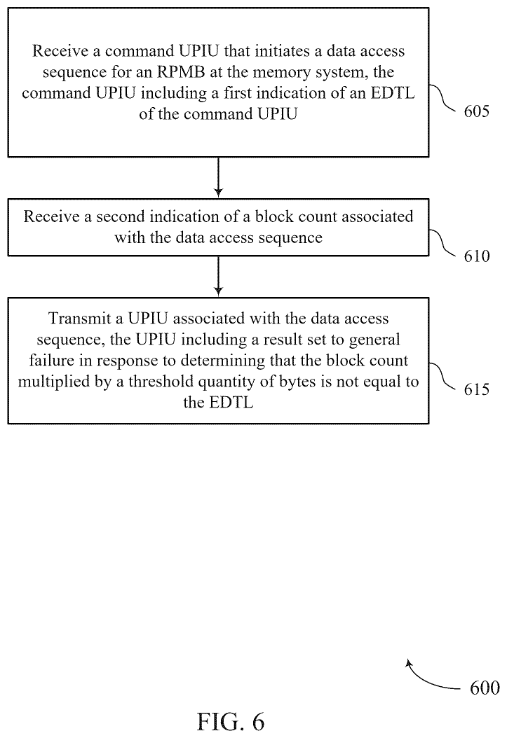

FIG. 6 shows a flowchart illustrating a method 600 that supports error handling for RPMB access commands in a memory system in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include receiving a command UPIU that initiates a data access sequence for an RPMB at the memory system, the command UPIU including a first indication of an EDTL of the command UPIU. In some examples, aspects of the operations of 605 may be performed by a UPIU reception component 425 as described with reference to FIG. 4.

At 610, the method may include receiving a second indication of a block count associated with the data access sequence. In some examples, aspects of the operations of 610 may be performed by a block count indication component 435 as described with reference to FIG. 4.

At 615, the method may include transmitting a UPIU associated with the data access sequence, the UPIU including a result set to general failure in response to determining that the block count multiplied by a threshold quantity of bytes is not equal to the EDTL. In some examples, aspects of the operations of 615 may be performed by a general failure result component 440 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:
Aspect 9: A method, apparatus, or non-transitory computer-readable medium including operations, features, circuitry, logic, means, or instructions, or any combination thereof for receiving a command UPIU that initiates a data access sequence for an RPMB at the memory system, the command UPIU including a first indication of an EDTL of the command UPIU; receiving a second indication of a block count associated with the data access sequence; and transmitting a UPIU associated with the data access sequence, the UPIU including a result set to general failure in response to determining that the block count multiplied by a threshold quantity of bytes is not equal to the EDTL.
Aspect 10: The method, apparatus, or non-transitory computer-readable medium of aspect 9, where the data access sequence includes a data write sequence in accordance with RPMB operations at the memory system.
Aspect 11: The method, apparatus, or non-transitory computer-readable medium of aspect 9, where the data access sequence includes a data read sequence in accordance with RPMB operations at the memory system.
Aspect 12: The method, apparatus, or non-transitory computer-readable medium of any of aspects 9 through 11, where receiving the second indication of the block count includes operations, features, circuitry, logic, means, or instructions, or any combination thereof for receiving a data out UPIU associated with the command UPIU, where the data out UPIU includes the second indication of the block count.
Aspect 13: The method, apparatus, or non-transitory computer-readable medium of aspect 12, where the threshold quantity of bytes is 512 bytes.
Aspect 14: The method, apparatus, or non-transitory computer-readable medium of any of aspects 9 through 11, where the command UPIU includes an EHS that includes the second indication of the block count and the UPIU including the result set to general failure includes a response UPIU transmitted in response to the command UPIU.
Aspect 15: The method, apparatus, or non-transitory computer-readable medium of aspect 14, where the threshold quantity of bytes is 4096 bytes.
Aspect 16: The method, apparatus, or non-transitory computer-readable medium of any of aspects 9 through 15, where the UPIU including the general failure result is transmitted in response to the second indication of the block count indicating that the block count is greater than zero.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a command universal flash storage (UFS) protocol information unit (UPIU) associated with a data access sequence for a replay protected memory block (RPMB) of the memory system, the command UPIU comprising a first indication of an expected data transfer length (EDTL) of the command UPIU and a second indication of a second length of the command UPIU; and
transmit a response UPIU comprising a check condition status in response to determining that the EDTL does not equal the second length.

2. The memory system of claim 1, wherein the second length is a transfer length of the command UPIU or an allocation length of the command UPIU.

3. The memory system of claim 1, wherein the data access sequence is an authenticated data write sequence in accordance with RPMB operations at the memory system.

4. The memory system of claim 1, wherein the data access sequence is an authenticated data read sequence in accordance with RPMB operations at the memory system.

5. The memory system of claim 1, wherein the response UPIU is transmitted in response to the command UPIU.

6. The memory system of claim 1, wherein the command UPIU comprises an extra header segment (EHS) and initiates the data access sequence.

7. The memory system of claim 1, wherein the processing circuitry is further configured to cause the memory system to:
refrain from communicating one or more UPIUs of the data access sequence in response to determining that the EDTL does not equal the second length, wherein the one or more UPIUs comprise one or more of a ready to transfer UPIU associated with the command UPIU, a data out UPIU associated with the command UPIU, and a data in UPIU associated with the command UPIU.

8. The memory system of claim 1, wherein the processing circuitry is further configured to cause the memory system to:
receive a third indication of a block count associated with the data access sequence; and
transmit a UPIU associated with the data access sequence, the UPIU comprising a result set to general failure in response to determining that the block count multiplied by a threshold quantity of bytes is not equal to the EDTL.

9. A memory system, comprising:
one or more memory devices; and
processing circuitry coupled with the one or more memory devices and configured to cause the memory system to:
receive a command universal flash storage (UFS) protocol information unit (UPIU) that initiates a data access sequence for a replay protected memory block (RPMB) at the memory system, the command UPIU comprising a first indication of an expected data transfer length (EDTL) of the command UPIU;
receive a second indication of a block count associated with the data access sequence; and
transmit a UPIU associated with the data access sequence, the UPIU comprising a result set to general failure in response to determining that the block count multiplied by a threshold quantity of bytes is not equal to the EDTL.

10. The memory system of claim 9, wherein the data access sequence comprises a data write sequence in accordance with RPMB operations at the memory system.

11. The memory system of claim 9, wherein the data access sequence comprises a data read sequence in accordance with RPMB operations at the memory system.

12. The memory system of claim 9, wherein receiving the second indication of the block count comprises the processing circuitry configured to cause the memory system to:
receive a data out UPIU associated with the command UPIU, wherein the data out UPIU comprises the second indication of the block count.

13. The memory system of claim 12, wherein:
the threshold quantity of bytes is 512 bytes.

14. The memory system of claim 9, wherein:
the command UPIU comprises an extra header segment (EHS) that includes the second indication of the block count, and
the UPIU comprising the result set to general failure comprises a response UPIU transmitted in response to the command UPIU.

15. The memory system of claim 14, wherein:
the threshold quantity of bytes is 4096 bytes.

16. The memory system of claim 9, wherein the UPIU comprising the general failure result is transmitted in response to the second indication of the block count indicating that the block count is greater than zero.

17. A non-transitory computer-readable medium storing code comprising instructions which, when executed by processing circuitry of a memory system, cause the memory system to:
receive a command universal flash storage (UFS) protocol information unit (UPIU) associated with a data access sequence for a replay protected memory block (RPMB) of the memory system, the command UPIU comprising a first indication of an expected data transfer length (EDTL) of the command UPIU and a second indication of a second length of the command UPIU; and
transmit a response UPIU comprising a check condition status in response to determining that the EDTL does not equal the second length.

18. The non-transitory computer-readable medium of claim 17, wherein the second length is a transfer length of the command UPIU or an allocation length of the command UPIU.

19. The non-transitory computer-readable medium of claim 17, wherein the data access sequence is an authenticated data write sequence in accordance with RPMB operations at the memory system or an authenticated data read sequence in accordance with RPMB operations at the memory system.

20. The non-transitory computer-readable medium of claim 17, wherein the response UPIU is transmitted in response to the command UPIU.

21. The non-transitory computer-readable medium of claim 17, wherein the instructions, when executed by the processing circuitry of the memory system, further cause the memory system to:
refrain from communicating one or more UPIUs of the data access sequence in response to determining that the EDTL does not equal the second length, wherein the one or more UPIUs comprise one or more of a ready to transfer UPIU associated with the command UPIU, a data out UPIU associated with the command UPIU, and a data in UPIU associated with the command UPIU.

22. A non-transitory computer-readable medium storing code comprising instructions which, when executed by processing circuitry of a memory system, cause the memory system to:
receive a command universal flash storage (UFS) protocol information unit (UPIU) that initiates a data access sequence for a replay protected memory block (RPMB) at the memory system, the command UPIU comprising a first indication of an expected data transfer length (EDTL) of the command UPIU;
receive a second indication of a block count associated with the data access sequence; and
transmit a UPIU associated with the data access sequence, the UPIU comprising a result set to general failure in response to determining that the block count multiplied by a threshold quantity of bytes is not equal to the EDTL.

23. The non-transitory computer-readable medium of claim 22, wherein the data access sequence comprises a data write sequence in accordance with RPMB operations at the memory system or a data read sequence in accordance with RPMB operations at the memory system.

24. The non-transitory computer-readable medium of claim 22, wherein the UPIU comprising the result set to general failure comprises a data in UPIU of the data access sequence, and wherein receiving the second indication of the block count comprises:
receiving a data out UPIU associated with the command UPIU, wherein the data out UPIU comprises the second indication of the block count.

25. The non-transitory computer-readable medium of claim 22, wherein the command UPIU comprises an extra header segment (EHS) that includes the second indication of the block count, and wherein the UPIU comprising the result set to general failure comprises a response UPIU transmitted in response to the command UPIU.
